(19) United States
(12) Patent Application Publication
(10) Pub. No.: US 2013/0220996 A1
(43) Pub. Date: Aug. 29, 2013

(54) INDUCTION HEATER SYSTEM FOR ELECTRICALLY HEATED PIPELINES

(71) Applicant: David John Liney, Boughton Heath Chester (GB)

(72) Inventor: David John Liney, Boughton Heath Chester (GB)

(21) Appl. No.: 13/884,304

(22) PCT Filed: Nov. 7, 2011
(86) PCT No.: PCT/US11/59562

§ 371 Date: May 9, 2013

Related U.S. Application Data
(60) Provisional application No. 61/411,561, filed on Nov. 9, 2010.

(51) Int. Cl. H05B 6/04

(52) U.S. Cl. CPC H05B 6/04
USPC 219/660; 29/602.1

(57) ABSTRACT

An induction heater system, comprising an induction heating coil, wherein said induction heating coil has a first end and a second end, and a circumference; a power source electrically connected to said first end and said second end; an electrical connection through said induction heating coil and between said first end and said second end and said power source; and a gap located along said circumference of said induction heating coil, wherein said gap extends substantially longitudinally along the induction heating coil and divides said circumference of said induction heating coil into a first section and a second section.

### FIELD OF THE INVENTION

The invention is directed towards an apparatus for induction heating of short segments of pipeline systems, particularly when temporary induction heaters must be installed quickly and simply.

### BACKGROUND

U.S. Pat. No. 5,241,147 discloses a method and apparatus for heating a transport pipeline by inductive heating. The transport pipeline has a thermal insulator mounted on an outside surface thereof. A pair of parallel extending electric wires without metallic protection, are mounted on an outside surface of the thermal insulator. U.S. Pat. No. 5,241,147 is herein incorporated by reference in its entirety.

U.S. Pat. No. 6,278,095 discloses a subsea pipeline system having jumpers (short segments connecting equipment or wells and the main segments) that can be electrically heated. The jumpers are heated by induction coils placed around the jumpers, either before placing the jumpers subsea or afterward. Electrical power may be supplied to the induction coils from current flow in the walls of the heated segment of pipeline or from an external source such as from a subsea transformer or ROV. U.S. Pat. No. 6,278,095 is herein incorporated by reference in its entirety.

U.S. Pat. No. 6,509,557 discloses an apparatus and method for heating single insulated flowlines. Apparatus and method are provided for electrically heating subsea pipelines. An electrically/thermally insulating layer is placed over the pipe in the segment of the pipeline to be heated and electrical current is caused to flow axially through the steel wall of the pipe. In one embodiment (end fed), an insulating joint at the host end of the pipeline is used to apply voltage to the end of the segment. At the remote end an electrical connector is used to conduct the electrical current to a return cable or to a seawater electrode. A buffer zone of the pipeline beyond the remote end is provided. Separate electrical heating may also be applied in the buffer zone. Electrical chokes may be used in different arrangements to decrease leakage current in the pipeline outside the heated segment. In another embodiment (center fed), voltage is applied at or near the midpoint of the segment to be heated through an electrical connector and no insulating joint is used. Buffer zones, heating of buffer zones and electrical chokes may also be employed in this embodiment. U.S. Pat. No. 6,509,557 is herein incorporated by reference in its entirety.

U.S. Pat. No. 6,688,900 discloses an Electrical Insulating Joint (EIJ) for a pipe-in-pipe electrically heated pipeline. A ceramic disk under compressive load and dielectrics in an annulus provide electrical isolation and mechanical strength. An insulative liner extends around the ceramic disk to provide electrical isolation when materials other than hydrocarbons pass through the EIJ. The insulative liner may be extended through a knee joint. Pressure ports may be used to monitor fluid leaks and a built-in transformer may be used to monitor electrical leakage current. U.S. Pat. No. 6,688,900 is herein incorporated by reference in its entirety.

U.S. Pat. No. 6,739,803 discloses methods for installing an electrically heated pipe-in-pipe pipeline on the seafloor. Inner and outer pipe segments are formed and the inner pipe is coated and insulated. Coating may include sprayed polyurethane foam and insulating half-shells that are placed around welds. Epoxy is preferably coated on the inner pipe before other coatings. The segments are loaded on a lay barge and water stops are preferably installed in the annulus as the pipeline is formed. Water stops may be formed by placing a liquid polymer in the annulus and allowing it to cure.

There is a need in the art for one or more of the following:

Improved systems and methods for heating short sections of pipelines;

Improved systems and methods of using temporary induction heaters on pipelines;

Improved systems and methods for using temporary induction heaters on subsea pipelines installed via remotely operated vehicles;

Improved systems and methods for using temporary induction heaters on subsea pipelines installed via remotely operated vehicles that do not require electrical connections to be made in seawater.

### SUMMARY OF THE INVENTION

One aspect of the invention provides an induction heater system comprising an induction heating coil, wherein said induction heating coil has a first end and a second end and a circumference; a power source electrically connected to said first end and said second end; an electrical connection through said induction heating coil and between said first end and said second end and said power source; and a gap located along said circumference of said induction heating coil, wherein said gap extends substantially longitudinally along the induction heating coil and divides said circumference of said induction heating coil into a first section and a second section.

Another aspect of the invention provides a method comprising providing an induction heating coil, said induction heating coil having a first end and a second end and a gap located along a circumference of said induction heating coil, wherein said gap extends substantially longitudinally along the induction heating coil and divides said circumference of said induction heating coil into a first section and a second section; transmitting electrical current from a power source to said first end or to said second end; electrically connecting said induction heating coil to said first end and said second end and to said power source; installing said induction heating coil on a structure; and heating said structure by transmitting said electrical current through said induction heating coil.

### BRIEF DESCRIPTION OF THE DRAWINGS

So that the features and advantages of the present invention can be understood in detail, a more particular description of the invention may be had by reference to the embodiments thereof that are illustrated in the appended drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 is a schematic diagram depicting an induction heating coil, the induction heating coil surrounding a section of pipe and connected to an A/C power source in accordance with an aspect of the present invention.

FIG. 2 is a schematic diagram depicting another embodiment of the induction heating coil.

FIG. 3 is a cross-sectional view through line Z-Z′ of FIG. 1, depicting the induction heating coil surrounding a section of pipe.

FIG. 4 is a schematic diagram depicting another embodiment of the induction heating coil, wherein the induction heating coil is wrapped around a sleeve, the sleeve and induction heating coil surrounding a section of pipe and connected to an A/C power source in accordance with an aspect of the present invention.

FIG. 5 is a cross-sectional view through line Y-Y′ of FIG. 4, depicting the induction heating coil and sleeve surrounding a section of pipe.

FIG. 6 is a schematic diagram depicting another embodiment of the induction heating coil, the induction heating coil surrounded by housing, the housing and induction heating coil surrounding a section of pipe and connected to a multiple phase A/C power source in accordance with an aspect of the present invention.

FIG. 7 is a cross-sectional view through line X-X′ of FIG. 6, depicting the induction heating coil and housing surrounding a section of pipe.

FIG. 8 is a schematic diagram of a cross-section of yet another embodiment of the induction heating coil, the induction heating coil containing multiple connection elements and centralizers.

FIG. 9 is a schematic diagram depicting use of an induction heating coil in a subsea environment.

### DETAILED DESCRIPTION

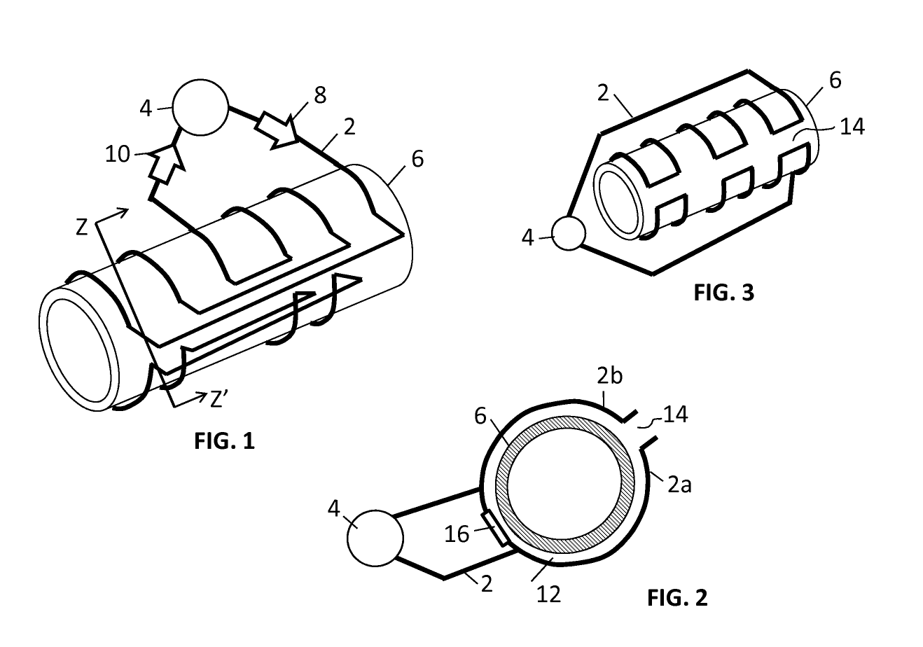

Presently preferred embodiments of the invention are shown in the above-identified figures and described in detail below. Embodiments may be described with reference to certain features and techniques for use on pipelines in a subsea environment. FIG. 1:

FIG. 1 is a schematic diagram depicting one embodiment of the induction heater apparatus. Induction heating coil 2 is connected to alternating current (A/C) power source 4 and surrounds pipe 6. A/C power source 4 may be used to supply the electrical power. A/C power source 4 commonly supplies 50 Hz or 60 Hz, but other frequencies may be selected to improve efficiency. A/C power source 4 may be an independent power source attached to induction heating coil 2, a separate power supply available near the pipeline, a power source provided by a Remotely Operated Vehicle (ROV), a power source provided by an umbilical, etc. A/C power source 4 may be connected to induction heating coil 2 such that no electrical connections are required during installation of induction heating coil 2.

Induction heating coil 2 may be, for example, a metallic cable capable of conducting an electric current, such as copper, or any other material as is known in the art. Induction heating coil 2 may be electrically insulated to prevent dissipation of energy to the surrounding environment by any method as is known in the art, including plastic coating, rubber, etc.

Pipe 6 may be, for example, circular pipe, square pipe, hexagonal pipe, or any other shape capable of being surrounded by induction heating coil 2. Pipe 6 may be any conductive material, for example, copper, steel, aluminum, etc. Pipe 6 may be a pipe of any length. The open ends shown on FIG. 1 should not be construed to indicate that pipe 6 should be a particular length or that the ends of pipe 6 must be accessible.

Electrical current may exit A/C power source 4 in the direction designated by arrow 8, flow through continuous induction heating coil 2, and return to A/C power source 4 in the direction designated by arrow 10. Electrical current may also flow in the reverse order, exiting A/C power source 4 in the opposite direction as arrow 10 and returning in the opposite direction as arrow 8. As electrical current imposed by A/C power source 4 flows through induction heating coil 2, a changing magnetic field is created and eddy currents form within pipe 6, causing a rise in thermal energy within pipe 6.

If an independent A/C power source 4 is used, the amount of current flowing through induction heating coil 2 may be controlled by the number of turns in the coil and by adjusting the voltage and frequency applied to induction heating coil 2. The resistance of the wire in induction heating coil 2 also affects current, but to minimize power requirements for A/C power source 4, the wire resistance is generally selected to be low enough so that most of the power dissipation is in the pipe and not in the coil wire. The method for controlling the amount of current flowing through induction heating coil 2 may be any method as is known in the art.

Methods for induction heating pipelines are explained more fully in U.S. Pat. No. 6,278,095, herein incorporated by reference in its entirety.

FIG. 2:

FIG. 2 is a cross-sectional view through the line Z-Z′ showing a loop of induction heating coil 2 surrounding pipe 6. Space 12 between induction heating coil 2 and pipe 6 may vary depending on the surrounding environment. Space 12 may be constant around the circumference of pipe 6, or space 12 may be greater on a first section of the circumference of pipe 6 than on a second section of the circumference of pipe 6, or space 12 may be non-existent, as when induction heating coil 2 physically contacts pipe 6. The requirement for space 12 may be determined for each environment.

Induction heating coil 2 contains a gap 14 on the circumference of induction heating coil 2. Induction heating coil 2 comprises at least two portions separated by gap 14, first section 2a and second section 2b. Gap 14 may extend longitudinally along induction heating coil 2 and may be sufficiently large such that induction heating coil 2 can easily be placed on pipe 6. In another embodiment, induction heating coil 2 may be sufficiently flexible such that gap 14 can be increased by applying force to first section 2a and/or second section 2b, thus allowing induction heating coil 2 to surround pipe 6, or sections 2a and 2b may have a clamshell arrangement with a hinge to allow the sections to open and close. Once induction heating coil 2 surrounds pipe 6, any applied force can be removed and/or first section 2a and/or second section 2b can be reshaped if any deformation has occurred. . Although the term circumference has been used, this does not indicate the shape of induction heating coil 2 should be circular in nature.

In another embodiment, first section 2a and second section 2b may be, for example, connected by a connection element 16. Connection element 16 may be located opposite gap 14, such that first section 2a and second section 2b are of equal length, or connection element 16 may be located such that first section 2a and second section 2b are of different lengths. The location of connection element 16 may be determined based on the required environment.

Connection element 16 may be, for example, any material capable of conducting an electric current. Connection element 16 may be a flexible or deformable material, such as copper, aluminum, etc., a hinge, a ball and socket joint, a screw, or any other method of attaching two pieces together. Connection element 16 may improve ease of installation and/or reduce the force necessary to increase gap 14 by providing a preferred pivot point or bending area. Connection element 16 may be electrically insulated to prevent dissipation of energy to the surrounding environment by any method as is known in the art, including plastic coating, rubber, etc.

Gap 14 may be increased by applying force to first section 2a and/or second section 2b, either with or without causing deformation of first section 2a and/or second section 2b. By increasing gap 14, induction heating coil 2 may surround pipe 6. First section 2a and/or second section 2b can be reshaped if any deformation has occurred.

Through use of a continuous induction heating coil 2 and gap 14, induction heating coil 2 may be easily installed anywhere on pipe 6. Induction heating coil 2 can be pre-fabricated and then quickly and easily installed on pipe 6 at surface or subsea, either by hand or by machine, such as via ROV for subsea use. When the section of pipe 6 has been sufficiently heated, induction heating coil 2 can be quickly removed and installed on another section of pipe 6 that requires induction heating. A single induction heating coil 2 may be intentionally deformed or sized to allow induction heating coil 2 to be installed on various shapes and sizes of pipe 6 used in a surface or subsea environment.

Electrical insulation or other protection may be included along induction heating coil 2, A/C power source 4, connection element 16, or on any other portion of the system to protect against adverse conditions.

FIG. 3:

One alternative arrangement of induction heating coil 2 around pipe 6 is shown in FIG. 3. Induction heating coil 2 may be arranged in any fashion sufficient to induce heat into pipe 6 while maintaining gap 14 to allow for installation of induction heating coil 2 around pipe 6. Other arrangements may include, for example, helical coils, zig zags, s-shapes, square loops, double wraps, etc. as are known in the art.

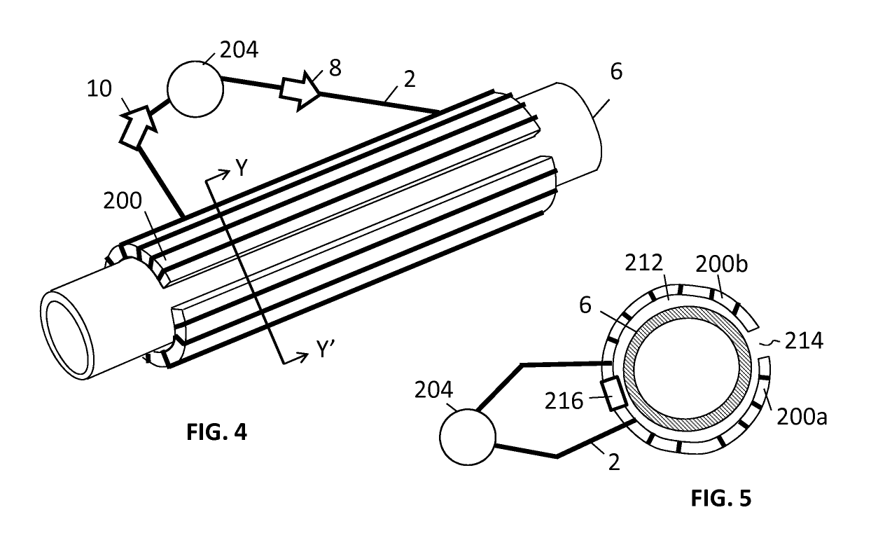

FIG. 4:

FIG. 4 is a schematic diagram depicting another embodiment of induction heating coil 2. Induction heating coil 2 forms a plurality of loops along the inner and outer surface of sleeve 200. Induction heating coil 2 is arranged in substantially parallel lines running in a substantially longitudinal direction along pipe 6. The space between each parallel section of induction heating coil 2 may be determined for the required application and may depend on the heat required, diameter of induction heating coil 2, diameter of pipe 6, or any other method as is known in the art. Sleeve 200 is preferably made from high relative magnetic permeability material formed in such a way, i.e. laminated, to minimize losses within the sleeve 200. Sleeve 200 may be electrically insulated to prevent dissipation of energy to the surrounding environment by any method as is known in the art, including plastic coating, rubber, etc.

Electrical current may exit A/C power source 204 in the direction designated by arrow 8, flow through continuous induction heating coil 2, and return to A/C power source 4 in the direction designated by arrow 10. Electrical current may also flow in the reverse order, exiting A/C power source 204 in the opposite direction as arrow 10 and returning in the opposite direction as arrow 8.

FIG. 5:

FIG. 5 is a cross-sectional view through the line Y-Y′ showing induction heating coil 2 and sleeve 200 surrounding pipe 6. Substantially parallel loops of induction heating coil 2 are shown wrapping around the inner and outer surface of sleeve 200.

Space 212 between induction heating coil 2 and/or sleeve 200 and pipe 6 may vary depending on the surrounding environment. Space 212 may be constant around the circumference of pipe 6, or space 212 may be greater on a first section of the circumference of pipe 6 than on a second section of the circumference of pipe 6, or space 212 may be non-existent, as when induction heating coil 2 and/or sleeve 200 physically contact pipe 6. The requirement for space 212 may be determined for each environment.

Sleeve 200 contains a gap 214 on the circumference of sleeve 200. Sleeve 200 comprises at least two portions separated by gap 214, first section 200a and second section 200b. Gap 214 may extend longitudinally along sleeve 200. In another embodiment, sleeve 200 may be sufficiently flexible such that gap 214 can be increased by applying force to first section 200a and/or second section 200b, thus allowing sleeve 200 to surround pipe 6. Once sleeve 200 surrounds pipe 6, any applied force can be removed and/or first section 200a and/or second section 200b can be reshaped if any deformation has occurred.

In another embodiment, induction heating coil 2 may be arranged such that A/C power source 204 is electrically connected to induction heating coil 2 so as to prevent induction heating coil 2 from extending across gap 214. The first and second ends of induction heating coil 2 may be electrically connected to A/C power source 204 near connection element 216 such that induction heating coil 2 does not interfere with installation of sleeve 200 about pipe 6. A/C power source 204 may be connected to induction heating coil 2 such that no electrical connections are required during installation of induction heating coil 2. Induction heating coil 2 may contain sufficient additional coil such that the additional coil may be between the inner surface of sleeve 200 and the outer surface of pipe 6 when sleeve 200 is installed onto pipe 6, or the additional coil may extend outside sleeve 200 and contact the outer surface of pipe 6. Alternatively, induction heating coil 2 may contain electrical connections such that induction heating coil 2 is electrically connected to A/C power source 204 once induction heating coil 2 and sleeve 200 are installed on pipe 6.

In another embodiment, first section 200a and second section 200b may be, for example, connected by a connection element 216. Connection element 216 may be located opposite gap 214, such that first section 200a and second section 200b are of equal length, or connection element 216 may be located such that first section 200a and second section 200b are of different lengths. The location of connection element 216 may be determined based on the required environment.

Connection element 216 may be, for example, a flexible or deformable material, such as copper, aluminum, etc., a hinge, a ball and socket joint, a screw, or any other method of attaching two pieces together. Connection element 216 may improve ease of installation and/or reduce the force necessary to increase gap 214 by providing a preferred pivot point or bending area. Connection element 216 may be any material capable of conducting an electric current, such as copper, steel, aluminum, etc. Connection element 216 may be electrically insulated to prevent dissipation of energy to the surrounding environment by any method as is known in the art, including plastic coating, rubber, etc. However, it will be appreciated by one of skill in the art that there may be cases where it is desirable to have connection element 216 be a non-metallic or non-conductive material, or where connection element 216 is removed from the system.

Gap 214 may be increased by applying force to first section 200a and/or second section 200b, either with or without causing deformation of first section 200a and/or second section 200b. By increasing gap 214, induction heating coil 2 and sleeve 200 may surround pipe 6. First section 200a and/or second section 200b can be reshaped if any deformation has occurred.

Through use of a continuous induction heating coil 2 surrounding sleeve 200, and gap 214, induction heating coil 2 and sleeve 200 may be easily installed anywhere on pipe 6. Induction heating coil 2 and sleeve 200 can be pre-fabricated and then quickly and easily installed on pipe 6 at surface or subsea, either by hand or by machine, such as via ROV for subsea use. When the section of pipe 6 has been sufficiently heated, induction heating coil 2 and sleeve 200 can be quickly removed and installed on another section of pipe 6 that requires induction heating. A single induction heating coil 2 and sleeve 200 may be intentionally deformed or sized to allow induction heating coil 2 and sleeve 200 to be installed on various shapes and sizes of pipe used in a surface or subsea environment.

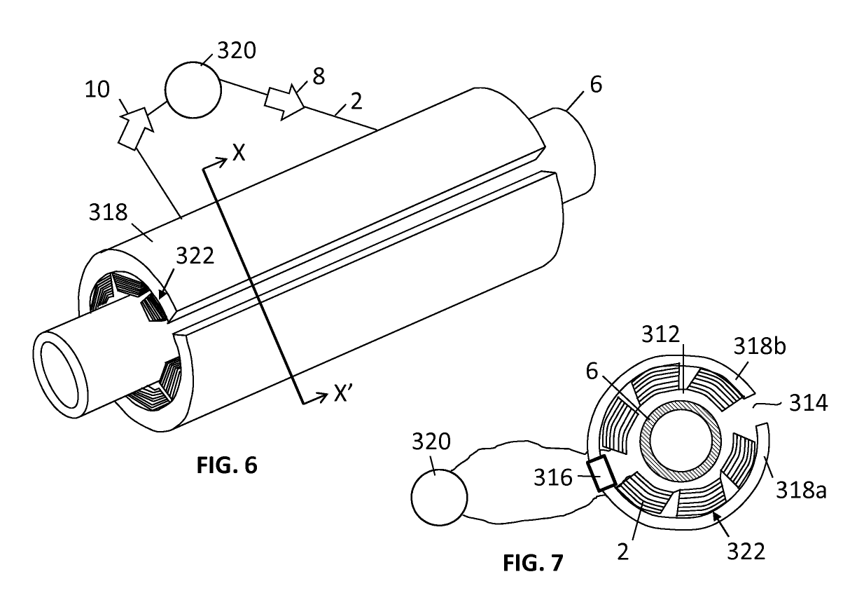

FIG. 6:

FIG. 6 is a schematic diagram depicting another embodiment of induction heating coil 2. Housing 318 contains induction heating coil 2. Induction heating coil 2 is arranged about the inner circumference of housing 318. A plurality of substantially parallel loops of induction heating coil 2 are formed into tight coil groups 322 that extend longitudinally along the inner surface of housing 318. Pairs of tight coil groups 322 are arranged circumferentially opposite each other about the inner surface of housing 381. The space between each parallel loop of induction heating coil 2, the space between tight coil groups 322, and the number of tight coil groups 322 may be determined for the required application and may depend on the heat required, diameter of induction heating coil 2, diameter of pipe 6, or any other method as is known in the art.

Housing 318 is preferably made from high relative magnetic permeability material formed in such a way, i.e. laminated, to minimize losses within the sleeve 200 may be any material capable of conducting an electric current, such as copper, steel, aluminum, etc. Alternatively, housing 318 may be an electrical insulated material to prevent dissipation of energy to the surrounding environment by any method as is known in the art, including plastic coating, rubber, etc.

Electrical current may exit multiple-phase A/C power source 320 in the direction designated by arrow 8, flow through continuous induction heating coil 2, and return to multiple-phase A/C power source 320 in the direction designated by arrow 10. Electrical current may also flow in the reverse order, exiting multiple-phase A/C power source 320 in the opposite direction as arrow 10 and returning in the opposite direction as arrow 8. Multiple-phase A/C power source 320 may produce three-phase current, a single phase, or be any other phase source as is known in the art. As electrical current exits multiple-phase A/C power source 320 and flows through induction heating coil 2, a rotating magnetic field is produced and eddy currents form within pipe 6.

FIG. 7:

FIG. 7 is a cross-sectional view through the line X-X′ showing induction heating coil 2 inside housing 318 surrounding pipe 6. Induction heating coil 2 is arranged into tight coil groups 322 about the inner circumference of housing 318. Pairs of tight coil groups 322 are arranged circumferentially opposite each other about the inner surface of housing 318.

Space 312 between induction heating coil 2 and pipe 6 may vary depending on the surrounding environment. Space 312 may be constant around the circumference of pipe 6, or space 312 may be greater on a first section of the circumference of pipe 6 than on a second section of the circumference of pipe 6, or space 312 may be non-existent, as when induction heating coil 2 physically contacts pipe 6. The requirement for space 312 may be determined for each environment.

Induction heating coil 2 and housing 318 contain a gap 314 on the circumference of housing 318. Housing 318 comprises at least two portions separated by gap 314, first section 318a and second section 318b. Gap 314 may extend longitudinally along housing 318, and gap 314 may be sufficiently large such that housing 318, which contains induction heating coil 2, can easily be installed on pipe 6. In another embodiment, housing 318, containing induction heating coil 2, may be sufficiently flexible such that gap 314 can be increased by applying force to first section 318a and/or second section 318b, thus allowing housing 318, containing induction heating coil 2, to surround pipe 6. Once housing 318, containing induction heating coil 2, surrounds pipe 6, any applied force can be removed and/or first section 318a and/or second section 318b can be reshaped if any deformation has occurred.

In another embodiment, induction heating coil 2 may be arranged such that multiple-phase A/C power source 320 is electrically connected to induction heating coil 2 so as to prevent induction heating coil 2 from extending across gap 314. The first and second ends of induction heating coil 2 may be electrically connected to multiple-phase A/C power source 320 near connection element 316 such that induction heating coil 2 does not interfere with installation of housing 318 about pipe 6. Multiple-phase A/C power source 320 may be connected to induction heating coil 2 such that no electrical connections are required during installation of induction heating coil 2. Induction heating coil 2 may contain sufficient additional coil such that induction heating coil 2 and housing 318 can be electrically connected to multiple-phase A/C power source 320 before being installed around pipe 6, wherein the additional coil is between the inner surface of tight coil groups 322 and the outer surface of pipe 6 when housing 318 is installed onto pipe 6, or the additional coil may extend outside housing 318 and contact the outer surface of pipe 6. Alternatively, induction heating coil 2 may contain electrical connections such that induction heating coil 2 is electrically connected to multiple-phase A/C power source 320 once induction heating coil 2 and housing 318 are installed on pipe 6.

In another embodiment, first section 318a and second section 318b may be, for example, connected by a connection element 316. Connection element 316 may be located opposite gap 314, such that first section 318a and second section 318b are of equal length, or connection element 316 may be located such that first section 318a and second section 318b are of different lengths. The location of connection element 316 may be determined based on the required environment.

Connection element 316 may be, for example, similar to connection element 216, as described above in reference to FIG. 7.

Gap 314 may be increased by applying force to first section 318a and/or second section 318b, either with or without causing deformation of first section 318a and/or second section 318b. By increasing gap 314, induction heating coil 2 and housing 318 may surround pipe 6. First section 318a and/or second section 318b can be reshaped if any deformation has occurred.

Through use of a continuous induction heating coil 2 contained within housing 318, and gap 314, housing 318, containing induction heating coil 2, may be easily installed anywhere on pipe 6. Housing 318, containing induction heating coil 2, can be pre-fabricated and then quickly and easily installed on pipe 6 at surface or subsea, either by hand or by machine, such as via ROV for subsea use. When the section of pipe 6 has been sufficiently heated, housing 318, containing induction heating coil 2, can be quickly removed and installed on another section of pipe 6 that requires induction heating. A single housing 318, containing induction heating coil 2, may be intentionally deformed or sized to allow housing 318, containing induction heating coil 2, to be installed on various shapes and sizes of pipe used in a surface or subsea environment.

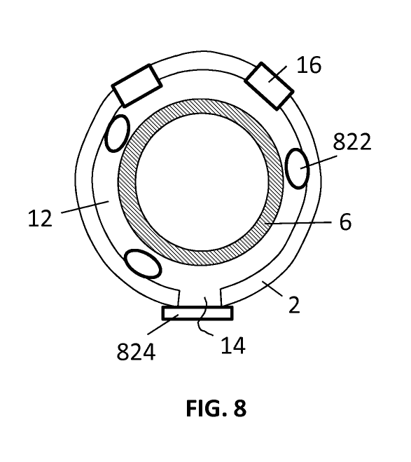

FIG. 8:

FIG. 8 is a schematic diagram of the cross-section of yet another embodiment of induction heating coil 2. As shown, induction heating coil 2 may be a coil as shown in FIG. 1 or FIG. 2, a coil wrapped around sleeve 200 as shown in FIG. 4, a coil located inside housing 318 as shown in FIG. 6, or any similar induction heating coil 2 as described herein. Induction heating coil 2 may contain a plurality of connection elements 16, 216, 316, as described in reference to FIGS. 1-7, arranged about the circumference and/or along the length of induction heating coil 2. In some embodiments there are from 1 to 10 connection elements 16, for example from about 2 to 7 connection elements 16, such as 2 connection elements 16 arranged at two locations less than 90 degrees apart and opposed gap 14, 214, 314. Additional connection elements 16 may improve ease of installation or removal, provide a preferred pivot point or bending area, allow the apparatus to accommodate varying pipe sizes, be included for redundancy, etc.

Induction heating coil 2 may contain a plurality of centralizers 822 arranged about the circumference and/or along the length of induction heating coil 2. In some embodiments there are from 1 to 10 centralizers 822, for example from about 2 to 7 centralizers 822, such as 3 centralizers 822 arranged at three locations 120 degrees apart. Centralizers 822 may be used to maintain a constant space 12 about pipe 6, to prevent induction heating coil 2 from directly contacting pipe 6, to maintain insulation about pipe 6 via fluid or gas in space 12, to prevent corrosion or damage to pipe 6, etc. Centralizers 822 may be a non-conducting or non-metallic material, such as rubber to prevent damage to pipe 6, or centralizers 822 may be an electrically conductive material, especially when used with insulated induction heating coil 2.

However, it will be appreciated by one of skill in the art that multiple connection elements 16 or centralizers 822 may be desired, and there may be applications where a single connection element 16 or centralizer 822 may be sufficient.

In another embodiment, centralizer 822 may be a sensor to measure a desired property, such as temperature, pressure, density, hydrocarbon content, etc. Centralizer 822 may be a sensor or may have an integrated sensor to provide information regarding the surrounding environment. It may be desirable to include sensors in sensitive environments, such as where temperature or pressure must be carefully controlled.

Locking element 824 may be located across gap 14, 214, 314. Locking element 824 may be a movable element such that locking element 824 is left in the open position, allowing induction heating coil 2 to be installed around pipe 6 via gap 14, then locking element 824 is engaged to prevent gap 14 from increasing, thus retaining induction heating coil 2 about pipe 6. Locking element 824 may be any non-metallic or non-conductive material, such as plastic, rubber, fabric, fiberglass, etc, or locking element 824 may be an electrically conductive material, such as copper, steel, aluminum, etc.

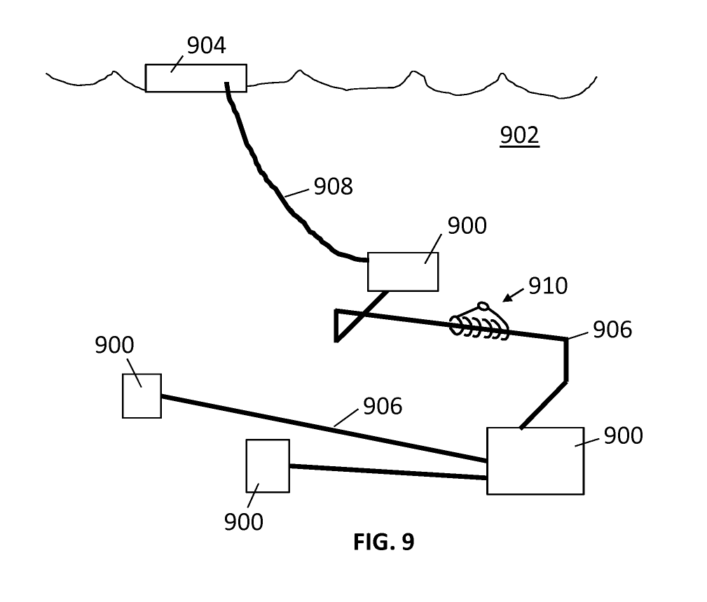

FIG. 9:

FIG. 9 is a schematic diagram depicting a subsea environment. Subsea equipment 900 may be a wellhead, blowout preventers, subsea manifold, subsea separation system, leak collection device, etc. Various portions of subsea equipment 900 are hydraulically connected to by pipelines 906. Pipelines 906 may be of varying sizes, shapes, and lengths as are known in the art. Surface pipeline connections 908 may connect subsea equipment 900 to surface equipment 904 located on top of sea 902.

An induction heating coil system 910, as more fully explained above in reference to FIGS. 1-8, may be installed on pipeline 906 to provide heat to pipeline 906. Induction heating for short segments of pipeline systems is explained more fully in U.S. Pat. No. 6,278,095, herein incorporated by reference in its entirety. Induction heating coil system 910 may be installed temporarily on any section of pipeline 906, surface pipeline connection 908, or on any other appropriate section of subsea equipment 900. Induction heating coil system 910 may also be permanently installed.

### Illustrative Embodiments:

In one embodiment, there is disclosed an induction heater system comprising an induction heating coil, wherein said induction heating coil has a first end and a second end and a circumference; a power source electrically connected to said first end and said second end; an electrical connection through said induction heating coil and between said first end and said second end and said power source; and a gap located on said circumference of said induction heating coil, wherein said gap extends substantially longitudinally along the induction heating coil and divides said circumference of said induction heating coil into a first section and a second section. In some embodiments, the system also includes a connection element located along said circumference of said induction heating coil, wherein said connection element is located between said first section and said second section. In some embodiments, the system also includes a sleeve, wherein said sleeve has a circumference, and said induction heating coil is longitudinally wrapped around said sleeve, and said gap is located along said circumference of said sleeve. In some embodiments, the system also includes a structure, wherein said induction heating coil surrounds said structure. In some embodiments, said power source is an alternating current power source. In some embodiments, said power source is a three-phase alternating current power source. In some embodiments, the system also includes a connection element located along said circumference of said sleeve, wherein said connection element is located between said first section and said second section. In some embodiments, the structure further comprises a subsea pipeline. In some embodiments, the system also includes a housing, wherein said housing has a circumference, and said induction heating coil is longitudinally wrapped in loops to form tight coil groups, wherein said tight coil groups are arranged circumferentially about the inner surface of said housing, and said gap is located along said circumference of said housing. In some embodiments, the system also includes a connection element located along said circumference of said housing, wherein said connection element is located between said first section and said second section. In some embodiments, the system also includes a plurality of said connection elements arranged circumferentially about said induction heating coil. In some embodiments, the system also includes a plurality of centralizers arranged circumferentially about said induction heating coil. In some embodiments, said centralizers further comprise sensors capable of measuring a property of the surrounding environment. In some embodiments, the system also includes a locking element located across said gap to prevent said gap from increasing in size. In some embodiments, said induction heating coil further comprises electrical insulation from an external environment.

In one embodiment, there is disclosed a method comprising providing an induction heating coil, said induction heating coil having a first end and a second end and a gap located along a circumference of said induction heating coil, wherein said gap extends substantially longitudinally along the induction heating coil and divides said circumference of said induction heating coil into a first section and a second section; transmitting electrical current from a power source to said first end or to said second end; electrically connecting said induction heating coil to said first end and said second end and to said power source; installing said induction heating coil on a structure; and heating said structure by transmitting said electrical current through said induction heating coil. In some embodiments, the method also includes removing said induction heating coil from said structure. In some embodiments, installing said induction heating coil is performed by a remotely operated vehicle. In some embodiments, the method also includes electrically insulating said induction heating coil from an external environment. In some embodiments, said structure is a subsea pipeline. In some embodiments, said power source is electrically connected to said induction heating coil before being placed in a subsea environment.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

We claim:

1. An induction heater system, comprising:
an induction heating coil, wherein said induction heating coil has a first end and a second end and a circumference;
a power source electrically connected to said first end and said second end;
an electrical connection through said induction heating coil and between said first end and said second end and said power source; and
a gap located along said circumference of said induction heating coil, wherein said gap extends substantially longitudinally along the induction heating coil and divides said circumference of said induction heating coil into a first section and a second section.

2. The induction heater system of claim 1, further comprising a connection element located along said circumference of said induction heating coil, wherein said connection element is located between said first section and said second section.

3. The induction heater system of claim 1, further comprising a sleeve, wherein said sleeve has a circumference, and said induction heating coil is longitudinally wrapped around said sleeve, and said gap is located on said circumference of said sleeve.

4. The induction heater system of claim 1, further comprising a structure, wherein said induction heating coil surrounds said structure.

5. The induction heater system of claim 1, wherein said power source is an alternating current power source.

6. The induction heater system of claim 1, wherein said power source is a three-phase alternating current power source.

7. The induction heater system of claim 3, further comprising a connection element located along said circumference of said sleeve, wherein said connection element is located between said first section and said second section.

8. The induction heater system of claim 4, wherein said structure further comprises a subsea pipeline.

9. The induction heater system of claim 1, further comprising a housing, wherein said housing has a circumference, and said induction heating coil is longitudinally wrapped in loops to form tight coil groups, wherein said tight coil groups are arranged circumferentially about the inner surface of said housing, and said gap is located along said circumference of said housing.

10. The induction heater system of claim 9, further comprising a connection element located along said circumference of said housing, wherein said connection element is located between said first section and said second section.

11. The induction heater system of claim 2, further comprising a plurality of said connection elements arranged circumferentially about said induction heating coil.

12. The induction heater system of claim 1, further comprising a plurality of centralizers arranged circumferentially about said induction heating coil.

13. The induction heater system of claim 12, wherein said centralizers further comprise sensors capable of measuring a property of the surrounding environment.

14. The induction heater system of claim 1, further comprising a locking element located across said gap to prevent said gap from increasing in size.

15. A method, comprising;
providing an induction heating coil, said induction heating coil having a first end and a second end and a gap located on a circumference of said induction heating coil, wherein said gap extends substantially longitudinally along the induction heating coil and divides said circumference of said induction heating coil into a first section and a second section;
transmitting electrical current from a power source to said first end or to said second end;
electrically connecting said induction heating coil to said first end and said second end and to said power source;
installing said induction heating coil on a structure; and
heating said structure by transmitting said electrical current through said induction heating coil.

16. The method of claim 15, further comprising removing said induction heating coil from said structure.

17. The method of claim 15, wherein installing said induction heating coil is performed by a remotely operated vehicle.

18. The method of claim 15, further comprising electrically insulating said induction heating coil from an external environment.

19. The method of claim 15, wherein said structure is a subsea pipeline.

20. The method of claim 15, wherein said power source is electrically connected to said induction heating coil before being placed in a subsea environment.

21. The induction heater system of claim 1, wherein said induction heating coil further comprises electrical insulation from an external environment.
